(19) United States
(12) Patent Application Publication
(10) Pub. No.: US 2006/0277087 A1
(43) Pub. Date: Dec. 7, 2006

(54) User interface for web analytics tools and method for automatic generation of calendar notes, targets,and alerts

(76) Inventor: Brett M. Error, Orem, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 11/374,816

(22) Filed: Mar. 13, 2006

Related U.S. Application Data
(60) Provisional application No. 60/688,138, filed on Jun. 6, 2005.
(60) Provisional application No. 60/688,076, filed on Jun. 6, 2005.

(51) Int. Cl. G06F 9/46

(52) U.S. Cl. 705/8

(57) ABSTRACT

Graphic user interfaces for a web analytic system include new modules for automatic generation of calendar notes, targets and alarms. The calendar module is a program for generation of user interfaces, maintenance of a calendar and display settings for same. In particular, the calendar module 208 allows calendar notes or flags to be added to data provided by the web analytics tool 210. These calendar notes or flags are displayed across all reports output by the web analytics tool 210. The calendar notes or events are particularly advantageous because they are: 1) user specific, but may be shared with others as set by the user, 2) allow the user to remember important dates or events automatically, 3) allow easy and direct comparison of pre/post event data, and the 4) the events can be a period of time in addition to a point in time. The functionality provided by the calendar module 208 will be fully described below in the calendar notes section and in conjunction with the description of FIGS. 4-7D.

### CROSS-REFERENCES To RELATED APPLICATIONS

The present application claims priority under 35 U.S.C. § 119(e) to U.S. Provisional Patent Application No. 60/688,138, filed on Jun. 6, 2005 by Brett M. Error entitled “User Interface For Web Analytics Tools And Method For Automatic Generation Of Calendar Notes, Targets, And Alarms;” and is related to U.S. Provisional Application Ser. No. 60/688,076, filed Jun. 6, 2005 by Chris Error et al., entitled “Website Traffic Analysis Engine and User Interface,” (Attorney Docket No. 10331), each of which is incorporated herein in its entirety by reference.

### BACKGROUND OF THE INVENTION

1. Field of the Invention

This invention relates generally to graphical user interfaces for tools relating to web analytics. More particularly, the present invention relates a method for adding calendar notes to a web analytics tool to display web analysis data in the context of certain important events. The present invention also relates to a method for setting targets for web and financial metrics, and comparing collected web data to those metrics.

2. Description of the Related Art

Web analytics basically refers to the analysis of data created by website usage. For instance, web analytics could be used to mine visitor traffic data. A variety of visitor traffic data is measured such as what browser is being used, what links on a given web page were selected, whether a product was purchased, etc. There are number of web analytics tools presently available such as Site Catalyst version 11 from Omniture of Orem, Utah. These tools are able to capture data on website usage, and responsive to a user's request display a variety of different metrics on website usage such fallout/conversion, A/B testing, etc.

One problem with such existing tools is that web site usage may be greatly affected by external events such changes to the web site, launch of an advertising campaign or events of interest to the users of the web site such as political events, sporting events, etc. It would be advantageous to provide a mechanism to reflect such events when the metric data described above is being presented to the user, so that fluctuations in the data may be associated or correlated to such events.

Another problem with existing web analytics tools is that there is no way to provide visual feedback on how metrics are changing relative to expected targets. Moreover, none of the existing web analytics tools have the capability to automatically notify or alert a user if a target is not met or has been met, or even more importantly before the target due date alert the user that the target is likely not to be met.

Thus, there is a need for an improved graphical user interface for web analytics tools that solves the above shortcomings of the prior art.

### SUMMARY OF THE INVENTION

The present invention includes a calendar module and a target module that may be used in conjunction with or added to a web analytics tool to provide new interfaces and displays for displaying calendar notes as to specific events and targets for specific metrics. These modules automatically generate calendar items and target alarms. The system includes an ability to display annotated web analytics data such as charts and graphs to indicate special dates of interest including a description of the event. The calendar annotations can cause the information to be displayed in different formats in relationship to the calendar note. The system also includes a target/goal system for setting goals for monitoring, automatic generation of alerts and reports specific to exceeding or failing to meet a target goal.

### BRIEF DESCRIPTION OF THE DRAWINGS

FIG. 1 is a block diagram of a system for operating the web analytics tool of the present invention.

FIG. 2 is block diagram of a preferred embodiment of the memory of the system of FIG. 1.

FIG. 3A is functional block diagram of the interaction of the system of the present invention with a user, a web analytics tool and a database.

FIG. 3B is a graphical representation of a graphical user interface according to prior art web analytics tools for presenting web analytics data.

FIG. 4 is a flow chart of a method for creating a calendar event or note according to one embodiment of the present invention.

FIGS. 5A-5C are graphical representations of user interfaces presented by the system in the process of creating a calendar note according to the present invention.

FIG. 6 is a flow chart of a method for displaying a calendar event or note according to one embodiment of the present invention.

FIG. 7A is a graphical representation of user interfaces for displaying calendar presets according to the present invention.

FIGS. 7B-7D are graphical representations of different embodiments of user interfaces for displaying calendar events according to the present invention.

FIG. 8 is a flow chart of a method for creating or adding targets according to one embodiment of the present invention.

FIGS. 9A-9C are graphical representations of embodiments of user interfaces for creating and setting targets according to the present invention.

FIG. 10 is a flow chart of a method for displaying targets according to one embodiment of the present invention.

FIGS. 11A-11D are graphical representations of embodiments of user interfaces for displaying targets according to the present invention.

### DETAILED DESCRIPTION OF THE PREFERRED EMBODIMENTS

The present invention is a system and method for generating a user interface for a web analytics tool that includes automatic generation of calendar items and target alarms. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Furthermore, the present invention is described below primarily in the context of web analytics data; however that is only by way of example, for convenience and ease of understanding of the concepts of the present invention. Those skilled in the art will recognize that the present invention is not limited to web analytics data but may also be used for any other type of data including but not limited to marketing data, sales data, application usage data, hardware usage data, financial data, health data, census data, etc.

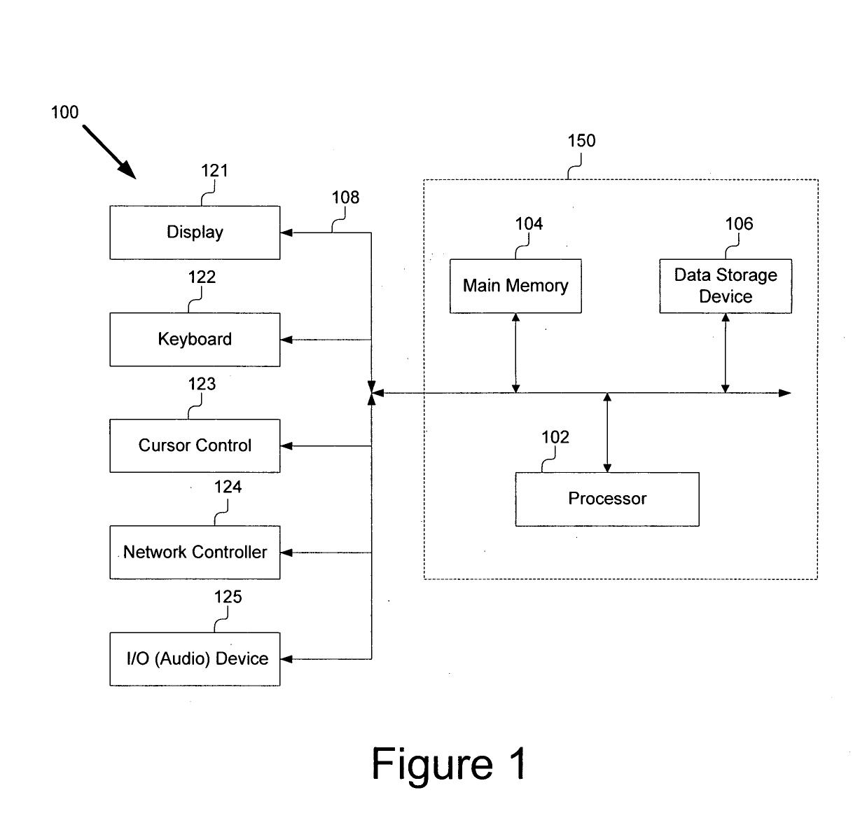

FIG. 1 is a block diagram of one embodiment of the system 100. While the present invention will now be described in the context of a von Neumann architecture, it should be understood that one embodiment of the present invention divides functionality in a client/server architecture. Referring to FIG. 1, the system 100 is shown as including a control unit 150, a display 121, a keyboard 122, a cursor controller 123, a network controller 124, and an input/output device 125. The control unit 150 is shown including a processor 102, main memory 104, and a data storage device 106, all of which are communicatively coupled to system bus 108.

Processor 102 processes data signals and may comprise various computing architectures including a complex instruction set computer (CISC) architecture, a reduced instruction set computer (RISC) architecture, or an architecture implementing a combination of instruction sets. Although only a single processor is shown in FIG. 1, multiple processors may be included.

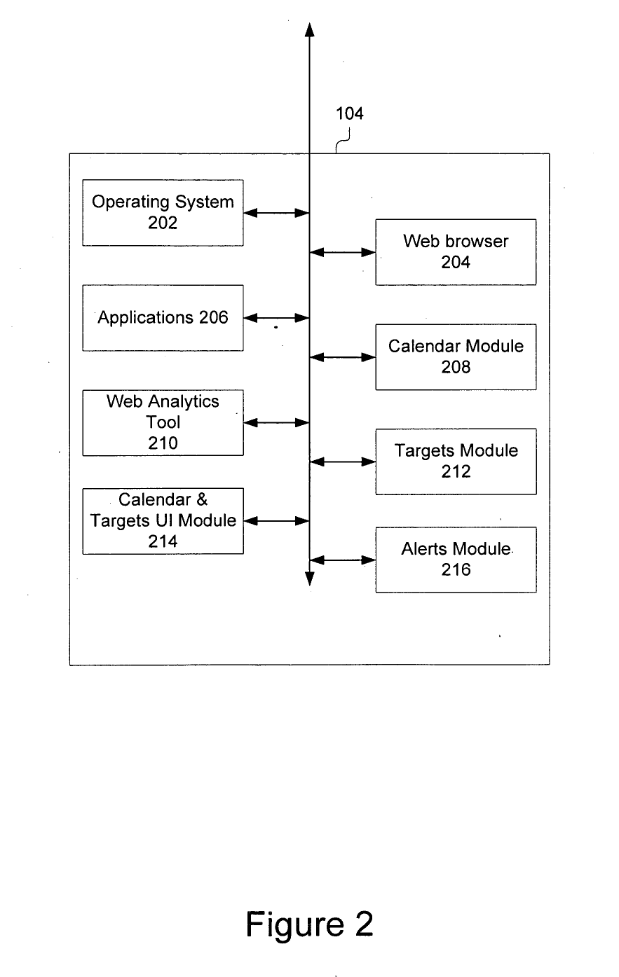

Main memory 104 may store instructions and/or data that may be executed by processor 102. The instructions and/or data may comprise code for performing any and/or all of the techniques described herein. Main memory 104 may be a dynamic random access memory (DRAM) device, a static random access memory (SRAM) device, or some other memory device known in the art. The memory 104 is described in more detail below with reference to FIG. 2. In particular, the portions of the memory 104 for providing automatic generation of calendar notes and targets are shown in detail.

Data storage device 106 stores data and instructions for processor 102 and may comprise one or more devices including a hard disk drive, a floppy disk drive, a CD-ROM device, a DVD-ROM device, a DVD-RAM device, a DVD-RW device, a flash memory device, or some other mass storage device known in the art. More specifically for Web analytics a disk array or multiple servers and associated database may be used as the data storage device 106.

System bus 108 represents a shared bus for communicating information and data throughout control unit 150. System bus 108 may represent one or more buses including an industry standard architecture (ISA) bus, a peripheral component interconnect (PCI) bus, a universal serial bus (USB), or some other bus known in the art to provide similar functionality.

Additional components coupled to control unit 150 through system bus 108 include display device 121, keyboard 122, cursor control device 123, network controller 124 and I/O device 125. Display device 121 represents any device equipped to display electronic images and data as described herein. Display device 121 may be a cathode ray tube (CRT), liquid crystal display (LCD), or any other similarly equipped display device, screen, or monitor. Keyboard 122 represents an alphanumeric input device coupled to control unit 150 to communicate information and command selections to processor 102. Cursor control 123 represents a user input device equipped to communicate positional data as well as command selections to processor 102. Cursor control 123 may include a mouse, a trackball, a stylus, a pen, a touch screen, cursor direction keys, or other mechanisms to cause movement of a cursor. Network controller 124 links control unit 150 to a network that may include multiple processing systems. The network of processing systems may comprise a local area network (LAN), a wide area network (WAN) (e.g., the Internet), and/or any other interconnected data path across which multiple devices may communicate.

One or more I/O devices 125 are coupled to the system bus 108. For example, the I/O device 125 may be an audio device 125 equipped to receive audio input and transmit audio output. Audio input may be received through various devices including a microphone within audio device 125 and network controller 124. Similarly, audio output may originate from various devices including processor 102 and network controller 124. In one embodiment, audio device 125 is a general purpose; audio add-in/expansion card designed for use within a general purpose computer system. Optionally, audio device 125 may contain one or more analog-to-digital or digital-to-analog converters, and/or one or more digital signal processors to facilitate audio processing.

It should be apparent to one skilled in the art that control unit 150 may include more or less components than those shown in FIG. 1 without departing from the spirit and scope of the present invention. For example, control unit 150 may include additional memory, such as, for example, a first or second level cache, or one or more application specific integrated circuits (ASICs). Similarly, additional components may be coupled to control unit 150 including, for example, image scanning devices, digital still or video cameras, or other devices that may or may not be equipped to capture and/or download electronic data to control unit 150.

FIG. 2 illustrates one embodiment of memory 104 of the present invention including operating system 202, a web browser 204, applications 206, a calendar module 208, a web analytics tool 210, a targets module 212, a calendar and targets user interface module 214, and an alerts module 216.

The operating system 202 is preferably one of a conventional type such as, WINDOWS®, SOLARIS® or LINUX® based operating systems.

The web browser 806 is of a conventional type that provides access to the Internet and processes HTML, XML or other mark up language to generated images on the display device 121. For example, the web browser 204 could be Mozilla Firefox or Microsoft Internet Explorer.

The memory unit 104 also includes one or more application programs 206 including, without limitation, word processing applications, electronic mail applications, spreadsheet applications, and web browser applications.

The memory 104 also includes a web analytics tool 210 such as Site Catalyst version 11 from Omniture of Orem, Utah. Such a tool 210 is disclosed in co-pending provisional patent application titled “Website Traffic Analysis Engine and User Interface,” Ser. No. 60/688,076, by Catherine Wong, Brett Error, Chris Error, and Josh Ezro, filed Jun. 6, 2005 which is incorporated by reference in its entirety.

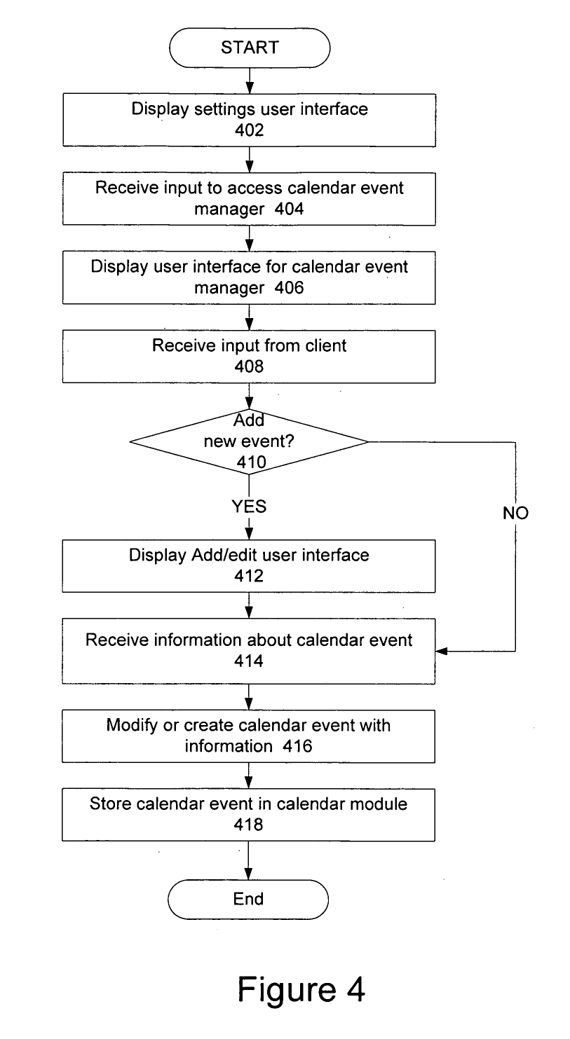

The calendar module 208 is a program or routines for maintenance of a calendar, creating associations between events and data and modifying or deleting events. In particular, the calendar module 208 allows calendar events to be added to data provided by the web analytics tool 210. These calendar events are displayed across all reports output by the web analytics tool 210. The calendar flags, notes or events are particularly advantageous because they are: 1) user specific, but may be shared with others as set by the user, 2) allow the user to remember important dates or events automatically, 3) allow easy and direct comparison of pre/post event data, and 4) the events can be a period of time in addition to a point in time. The calendar module 208 includes routines that receive user input specifing events that have occurred or will occur; and are of importance to the user in measuring metrics during, before and after the event. The calendar module 208 also generates user interface elements that can be combined with the reports generated by the web analytics tool 210. When these elements are combined with report, they show the event in reports when the user views the data that includes the event. More specifically, the calendar events are shown in views that are applicable overtime reports and trend views. Moreover, the calendar events can be used by the web analytics tool 210 to allow users to do A/B or split run testing based on the event. The functionality provided by the calendar module 208 will be more fully described below in the calendar notes section and in conjunction with the description of FIGS. 4-7D.

The targets module 212 is a program or routines for creation, maintenance and deletion of targets and forecasts. The targets module 212 is also capable of generating and sending alerts or message about targets. In particular, the targets module 212 allows target or goals to be added to data and reports from the web analytics tool 210, and these targets are displayed across all reports. The targets or goals are particularly advantageous because they are: 1) user specific, but may be shared with others as set by the user, 2) allow the user to directly compare targets to actual data, 3) provide an accountability matrix to determine which sectors are under or over performing, and 4) provide alerts that are automatically generated if a target is met, not met, or projected not to be met.

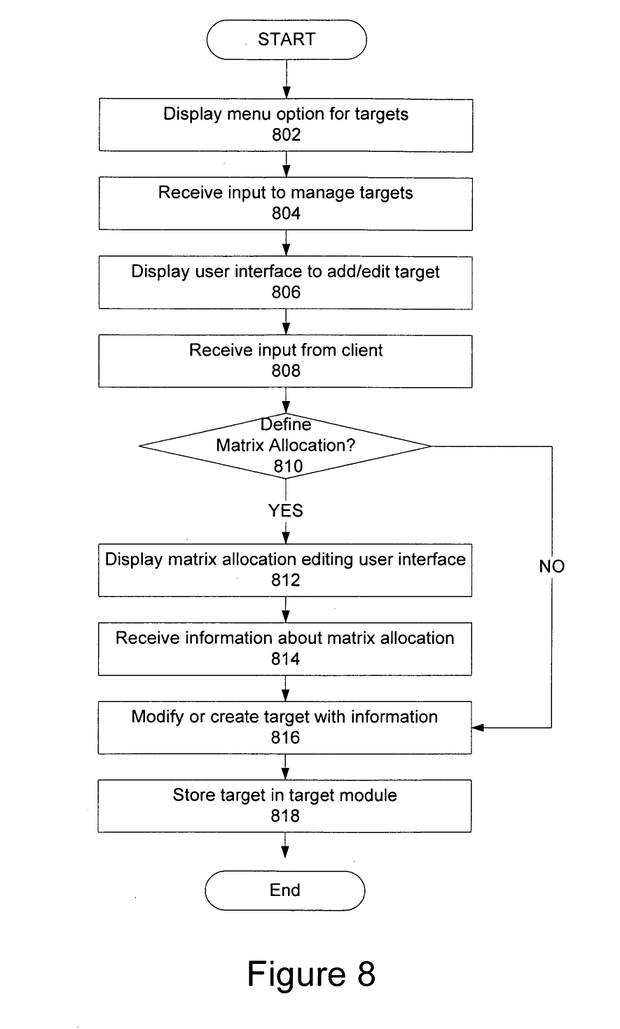

The targets module 212 allows users to define business targets for Key Performance Indicators or (metrics). This includes the ability to import targets (forecasts), from an external source. The targets module 212 also targets in reports, dashboard views, and current report objects as compared to actual data. In addition, targets module 212 sets alerts that will monitor actual data against targets more periodically (i.e., not just at the end of the period but rather during the period). In another embodiment the targets module 212 includes routines with the ability to forecast actual data to identify possible risks in meeting targets (use forecasting in alerts, targets views, and dashboard gauges). Finally, the targets module 212 generates and displays an accountability matrix that allows users to choose different breakdowns on a spreadsheet like structure, each breakdown appearing on one of the axis (e.g., Sales person on y-axis, and Sales Channel on x-axis), with each cell defining the Targets for the combination of those two dimensions and show how they compare to actual data (using different visual indicator such as colors for goals being met vs. not met). The functionality provided by the targets module 208 will also be more fully described below in the targets/goals section below and with reference to FIGS. 8-11D.

The calendar and targets user interface module 214 is a program or routines for generation of user interfaces corresponding to calendar events and targets. The calendar and targets user interface module 214 is coupled to the web analytics tool 210, the calendar module 208 and the targets module 212. The calendar and targets user interface module 214 receives data from each of these modules 208, 210 and 214 and creates one or more user interfaces for display of the combined information to the user. The operation of the calendar and targets user interface module 214 is described in more detail below.

The alerts module 216 is a program or routines for generating alerts. The alerts module 216 is communicatively coupled to the targets module 212, the calendar and targets user interface module 214 and the web analytics tool 210 to receive data for receiving information about targets, receiving user input regarding the alerts, and receiving actual data information, respectively. The alerts module 216 compares actual data to target data, and the conditions for the alert input by the user. If particular conditions are satisfied, the alerts module 216 displays an alert, sends a notification about the alert, or initiates another action. For example, in a typical alert, the user specifies watch for high or low values of the metric or in the case where there are targets the targets are met or not. Alerts by default are set to apply to all uncompleted periods. The alerts can be set to send notifications or alarms each day, week, month, quarter, half year, etc. The alerts based on a target period, automatically check at the end of each period and send an alert with one of the following messages: 1) target has been met, 2) metric exceeded target by n, 3) metric falls short of target by n. In another embodiment, the alerts module 216 checks multiple times during the period to determine if the target was met. If a target has been met during these periodic checks, an alert is sent and the periodic checks are disabled. In yet another embodiment, the alerts module 216 after half-way through the target time period, starts using the forecast to measure if the target is going to be met. If it is not going to be met, the alerts module 216 sends an alert. Those skilled in the art will recognize a number of variations or modifications that may be employed by the alerts module 216 and that are encompassed within the spirit and scope of the present invention.

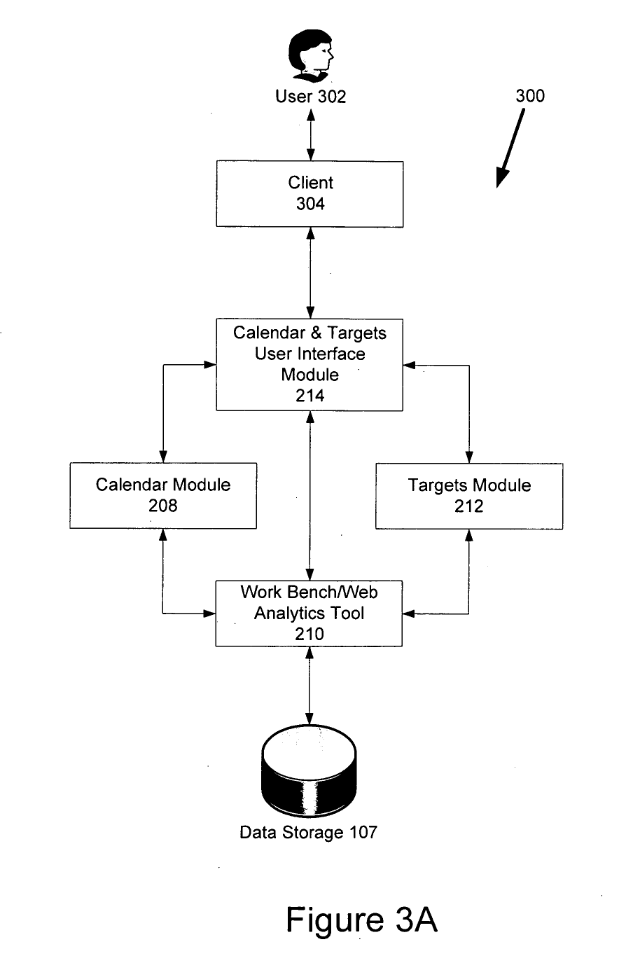

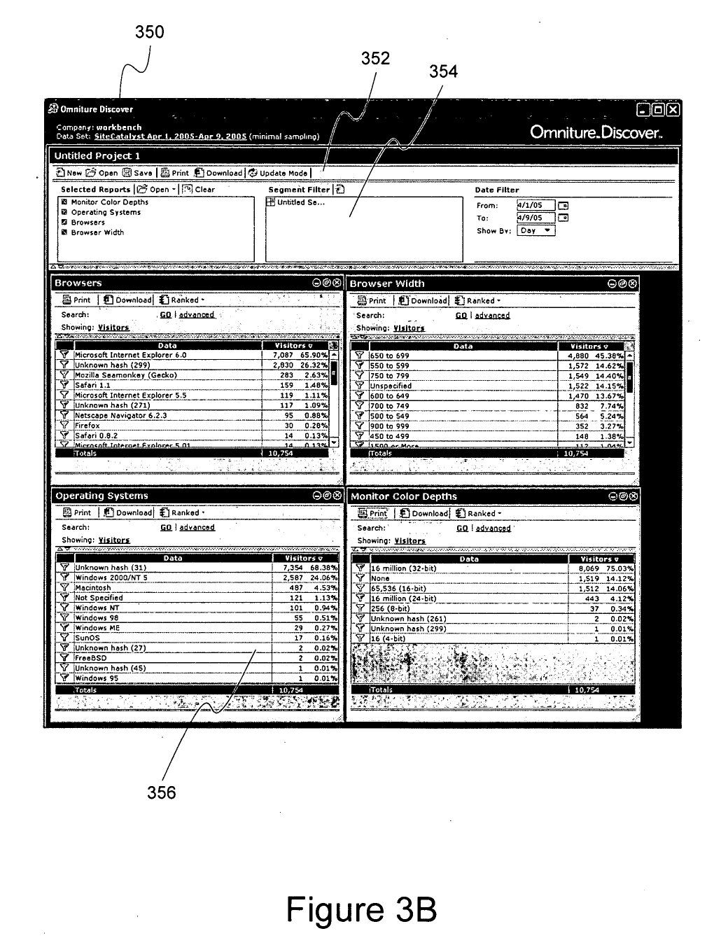

Referring now to FIG. 3A, a block diagram showing the interaction of the components of present invention in a web analytics system 300 will be described. The calendar and targets user interface module 214 presents an interface that allows a user 302 to input data that is sent to the calendar module 201 or the targets module 212 and used to set calendar events or targets. The calendar and targets user interface module 214 may also include a number of default settings, or data overlays previously created and stored by the user 300. The calendar and targets user interface module 214 is coupled for communication with the calendar module 201, the targets module 212 and the web analytics tool 210. The calendar and targets user interface module 214 is presents reports generated by the web analytics tool 210 with additional information and formatting depending on the output of the calendar module 201 and the targets module 212. The calendar module 201 or the targets module 212 creates, modifies or deletes calendar events or targets. These items are added to reports generated and output by the web analytics tool 210. The web analytics tool 210 is coupled to a data set or database in data storage 107. The data set can then be further manipulated by the web analytics tool 210 for the creation of reports, display to the user, tracking, targeting, and notification of users based on the data. Those skilled in the art will recognize that the functionality provided by the calendar and targets user interface module 214 may be integrated into the calendar module 208 and in such an embodiment the calendar module would interact directly with the client.

Referring now to FIG. 3B, an exemplary graphical user interface generated by the web analytics tool 210 for presenting web analytics data is shown. The user interface 350 includes a menu bar 352 for performing different operations on the data and in the presentation of the data. Any number of date reports may be generated and information used to generate the reports is provided in a report and filter section 354. The user interface 350 includes a plurality of tiles 365 for displaying the specific web analytics data. This is only one of a number of user interfaces generate by the web analytics tool 210. Those skilled in the art will recognize that the present invention can be used in conjunction with or in addition any of the reports and interfaces of the web analytics tool 210.

Creation of Calendar Events/Notes

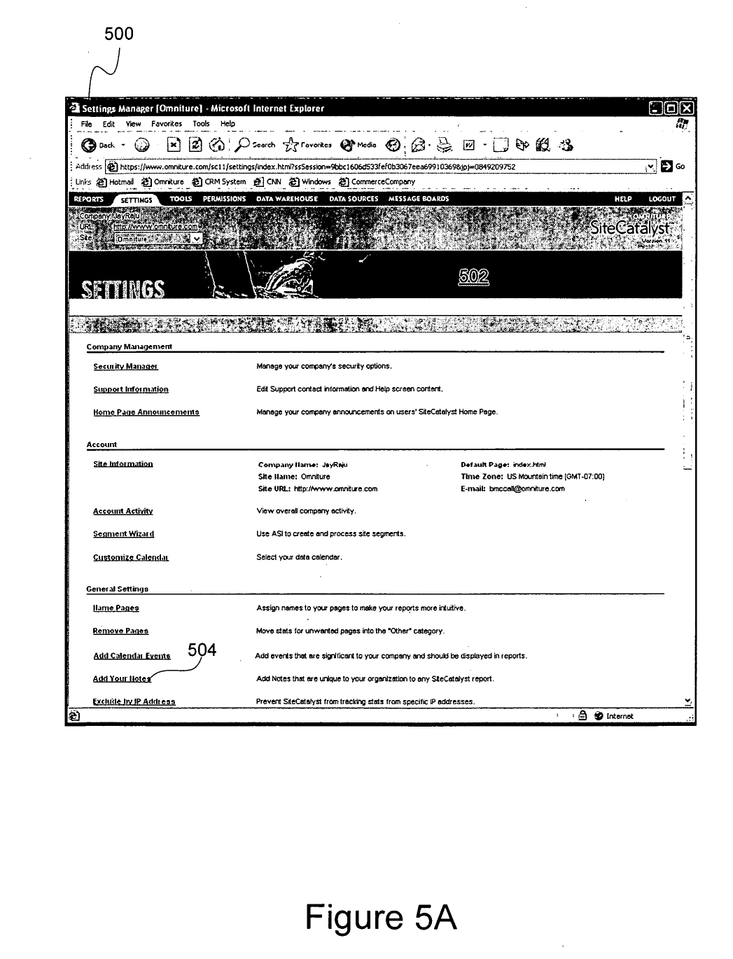

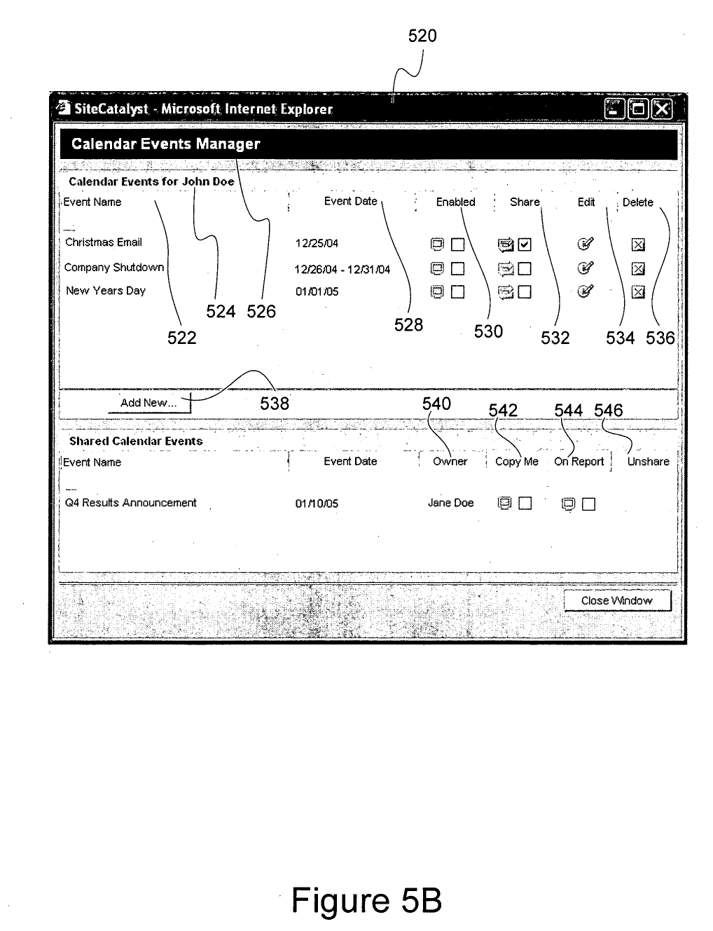

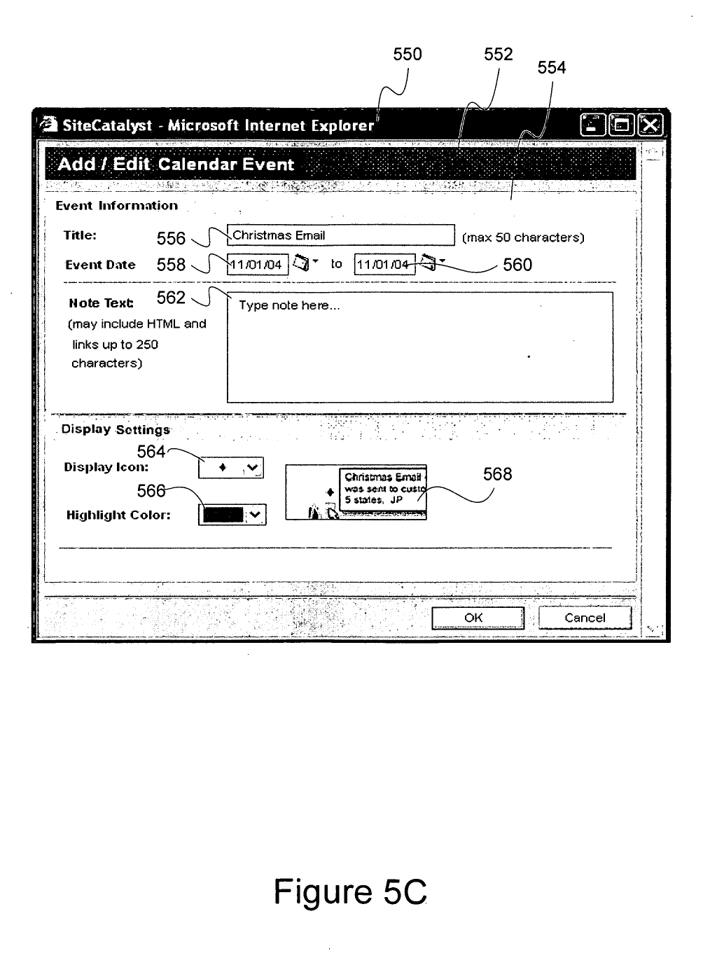

Referring now to FIGS. 4 and 5A-5C, one embodiment of a method for creating or adding calendar events will be described. The method begins by displaying 402, a user interface of general settings in which adding the calendar event is one option available for selection. FIG. 5A shows an exemplary such interface. The interface may be a window 500 such as displayable by a web browser. Within the window 500, a settings area 502 includes a variety of hypertext links that may be selected to modify different settings of the web analytics tool 210. Included within the variety of hypertext links is a link 504 to create new calendar notes or events. Those skilled in the art will recognize that while a hypertext link 504 is used that is only by way of example, and that a variety of other mechanisms may be used to initiate a process of creating new calendar events. The method continues by receiving 404 input from the user to access the calendar event manager. Next, the system 100 displays 406 a user interface for the calendar event manager.

An exemplary user interface for the calendar event manager is shown in FIG. 5B. In this embodiment, the calendar event manager is shown within a window 520 displayable by web browser. Within the window 520, an area 526 defines the calendar event manager. Within the calendar event manager area 526, there are a plurality of sections for specifying attributes of the calendar event. A first section 524 displays calendar events for this user. The first section 524 in this embodiment includes fields such as the event name 522, the event date 528, enabled 530, shared 532, edit 534, and delete 536. These fields provide information to the user or allow the user to modify the attributes of the calendar event. For example, the shared field 532 shows whether the calendar event is shared with other users of the system 100 as well as allows the user to select a checkbox to make the event shared with others. Similarly, the enabled field 530, the edit field 534, and the delete field 536 provided their described functionality with relationship to the calendar event. The calendar events manager includes a second area that shows the calendar events of others that are shared with this user. This second area includes a plurality of fields in addition to calendar event name and event date. Such fields include a field 540 specifying the owner of the calendar event, a field 542 specifying whether the user will be alerted about calendar of events, a field 544 to specify whether the event of another user should be shown on reports that the user is viewing, and a field 546 allowing the user to unshared or remove the calendar event of others from the user's reports. A key feature of the present invention is that the user has the ability to share her calendar events with other users using the share selector in the above window. Moreover calendar events can be copied and specific as to particular reports, although the default setting is across all reports. Finally, the calendar event manager includes a button 538 to add or create a new calendar event. This button 538 may be selected by the user as described in more detail below.

Referring now to FIG. 4, the method continues to receive 408 inputs from the client or user. The method then determines 410 whether the add new event button 538 has been selected. If not the method proceeds to step 414 as will be described below. However, if the add new event button 538 has been selected, the method continues to display 412 a calendar event creation user interface.

An exemplary embodiment of the calendar event creation user-interface is shown in FIG. 5C. A browser window 550 is used to display the calendar event creation user interface 552. The creation user interface 552 includes an area 554 to provide information about the event. The creation user-interface 552 includes a plurality of fields such as a title field 556, a event start date field 558, an event end date field 560, creation user interface 552 a note text field 562, a display settings area including a display icon field 564, a highlight color field 566, and an area 568 to display a rendering of how will the calendar event will appear in reports. The fields are self-explanatory by their names, however, for clarity the title field 556, provides an area for the user to input the name of the calendar event. The event start date field 558 provides an area for the user to specify the start date for the calendar event. The event and date field 560 provides an area for the user to specify the end date for the calendar event. The calendar event can be created by the specifying the same start and end date. However, the present invention is particularly advantageous because a calendar event can be created that spans a range of time by specifying a different start and end date using fields 558 and 560. The note text field 562 allows the user to add any text descriptor that she would like to be associated with the calendar event, and displayed with the calendar event. For example, when an icon appears in a report and the user moves the mouse over the icon in the report, the information in the note text field 562 is displayed.

The display icon field 564 is preferably a pulldown menu and allows the user to select from among a variety of different shapes which one will be used to designate the specific calendar event. The highlight color field 566 allows the user to select via a pulldown menu from a plurality of different colors that the display icon may have. So that the user can see how the calendar event will be displayed, the area 568 is provided and contains a rendering of the calendar event using the information input into the display icon field 564, the highlight color field 566, and the note text field 562.

Referring back now to FIG. 4, the method continues in step 414 to receive information about the calendar event. The information used in step 414 can either be from the information provided by the user using the creation user interface 552 or the calendar of events manager interface 526. The method then modifies or creates 416 the calendar event with the information provided in step 414. The calendar event is then stored 418 by the calendar module 408, and the creation process is complete.

Display of Calendar Events/Notes

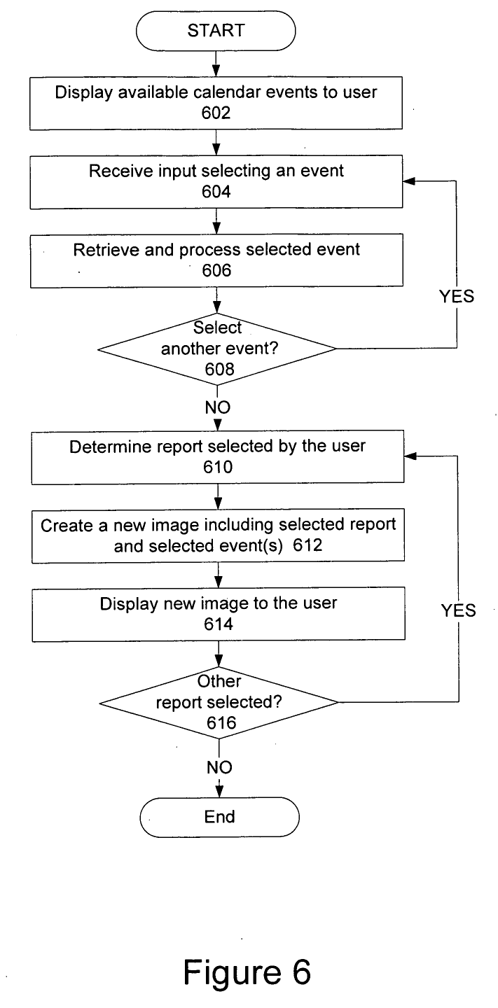

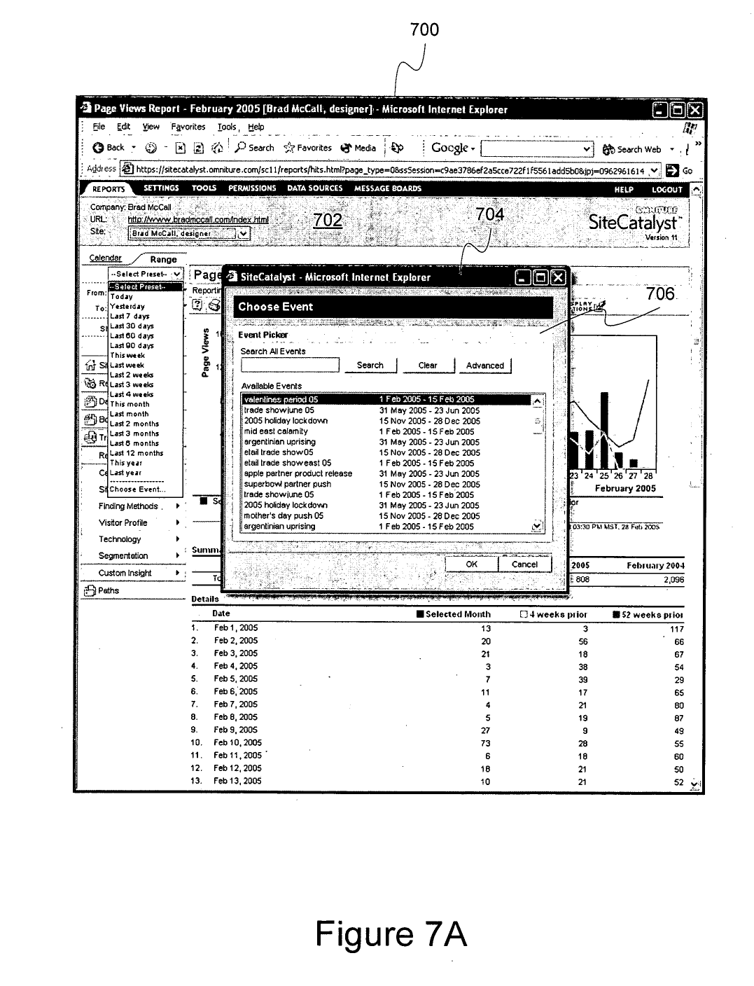

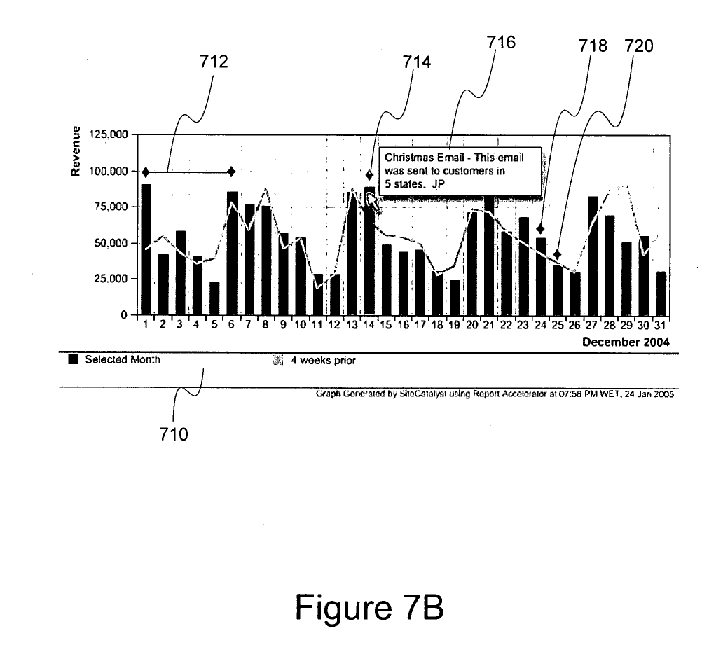

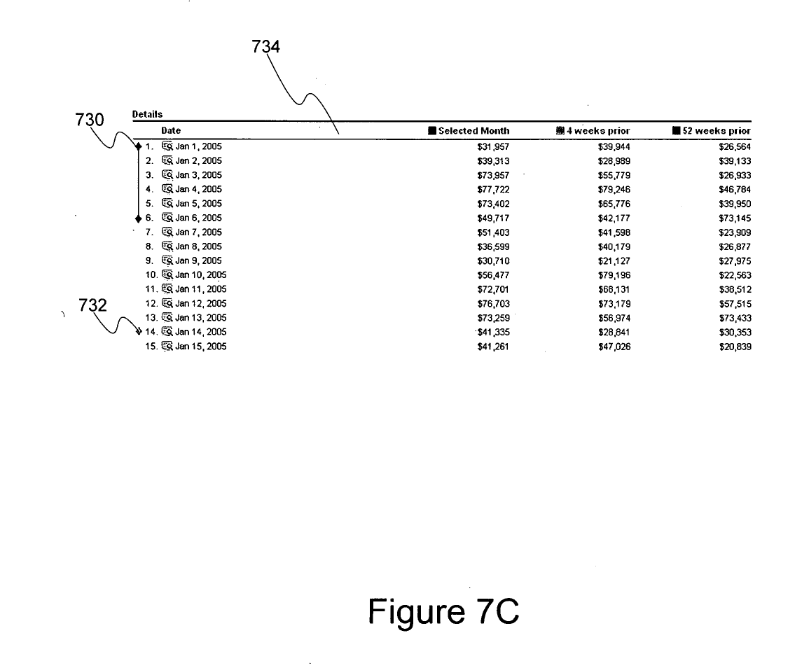

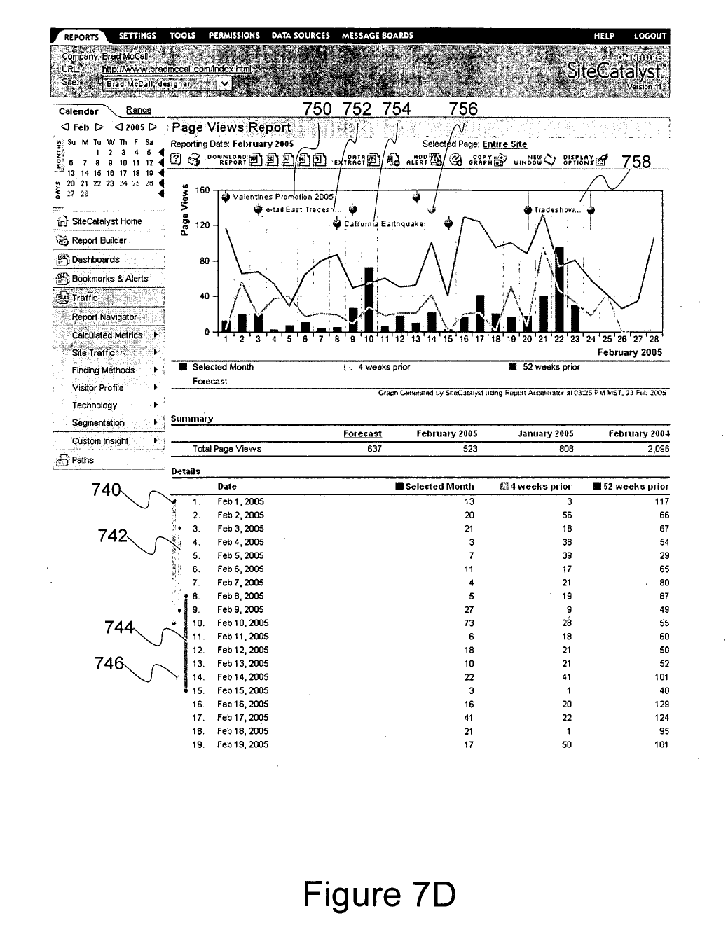

Referring now to FIG. 6, a method for displaying calendar events, in conjunction with reports from a Web analytics tool 210 will be described. The method begins by a displaying 602 available calendar events to the user. This can be done using the exemplary user interface shown in FIG. 7A which will be described in more detail below. Then the system 100 receives 604 inputs selecting an event. Next, the calendar module 208 retrieves and processes 606 the selected event. The present invention advantageously allows the user to select any number of events to be displayed across all reports. Thus, the method determines 608 whether another event has been selected. If another event has been selected, the method returns to step 604 and repeats the steps of receiving 604 input and processing 606 the selected event. If another event has not been selected, the method continues to step 610 to determine the report selected by the user. Then the calendar module 208 and the calendar and targets user interface module 214 creates 612 a new imaging including the select a report from step 610, and the selected event(s) from step 604. The system 100 then displays 614 the new image to the user. Next, the method determines 616 whether the user has selected another report. If so, the user is transitioning to view the data using another report. In such a case, the system 100 repeats steps 610, 612, 614, to generate a user interface that combines the information for the new report with the calendar of events.

Referring now to FIG. 7A, a graphical representation of a user interface for displaying calendar presets according to the present invention is shown. FIG. 7A shows a window 700 displayable by a Web browser. Within the window 700, a conventional user interface 702 for a Web analytics tool 210 and for the presentation of reports about Web analytics data is displayed. The present invention provides a preset drop-down window 704 that allows the user to specify which calendar events should be displayed in conjunction with the reports by using an event picker window 706. The default setting is preferably such that any selected calendar event will be displayed across all reports, as appropriate. The user, using the advanced settings, may select calendar event such that they are only displayed for particular reports. The present invention advantageously pre-populates the event picker window 706 with calendar events based on the identity of the user.

Referring now FIGS. 7B-7D, graphical representations of different embodiments of user interfaces for displaying calendar events according to the present invention are shown. FIG. 7B illustrates an exemplary report 710 generated by the Web analytics tool 210 and including calendar notes according to the present invention. In addition to the conventional information provided by the Web analytics report 710, the report includes a plurality of calendar notes 712, 714, 718, and 720. A first calendar note 712 illustrates how calendar note can be displayed to highlight a date range, in this case, the dates from December 1 to December 6. As shown in FIG. 7B, each of the calendar notes 712, 714, 718, and 720 are displayed with different colors, thereby making them easily distinguishable from each other. FIG. 7B further illustrates how a text annotation 716 associated with the calendar note 714 is displayed proximate the position of the calendar note 714 as the cursor is positioned over the point in time in the report, corresponding to the calendar event 714.

FIG. 7C illustrates another report 734 generated by the Web analytics tool 210. FIG. 7C illustrates a tabular report with a plurality of calendar events 730, 732 depicted to the left of the leftmost column. As can be seen, the calendar events have a similar presentation as and FIG. 7B.

FIG. 7D illustrates yet another embodiment for display of calendar events according to the present invention. The report shown in FIG. 7D is a combined report including both a table layout depiction of the day-to-day and a bar graph depiction of the data. In addition, the present invention provides a plurality of calendar events 740, 742, 744, 746, 750, 752, 754, 756, and 758. A first group of calendar events 740, 742, 744, 746 are displayed in conjunction with the table layout of the data. FIG. 7D illustrates that the calendar events may be shown as circles and/or interconnecting lines in contrast to the depiction of the calendar events of FIG. 7C. Again, the different calendar event can be displayed with different colors. Moreover, there is a second group of calendar events 750, 752, 754, 756, and 758 shown in conjunction with the bar graph depiction of the data. This second group of calendar events 750, 752, 754, 756, 758 is shown as circles with horizontal interconnecting lines of different colors. In addition, the event name for each event is displayed over the interconnecting lines if enough spaces provided. Furthermore, as can be seen the same event is depicted twice, once in the bar graphs portion of the display and once in the table portion of the display. For example, displayed calendar event 740 and 750 correspond to the same calendar event.

Based on the example displays shown in FIG. 7B-7D, those skilled in the art will recognize that there are a variety of options for displaying multiple bands specified for the same day that are selectable by the user. One option is to show a new icon (multi-set version of current icon) representing multiple events. On mouse over the new icon, the text for each event one after the other sorted by event name is shown. A second option is to show the icons one above the other (to the side in the case of a table). A third option is to use a fixed height for the event bar and scale as many events as you can in the fixed height (i.e., if there are two overlapping events, each will take half the fixed height.) Similarly, there are a number of options for showing the date range in graphs that are selectable by the user. One option is to display as lines (e.g. timeline); the line appears horizontally above the bars in the graph and vertically to the left for the table. Another option for overlapping events shows lines one above the other (graph) and one next to the other (table). Moreover, the user interface also presents subtotals. For example, subtotals in tables are show for an event with a duration (i.e., when a user moves the cursor on the line or the icon of the line, summary stats for the rows are displayed): Thus, one advantage of the present invention is the ability to provide a graphical display that shows both the metric data that the user is interested along with the calendar event or note such as show above for the horizontal bars on the graph and the vertical bars on the table.

Creation of Targets

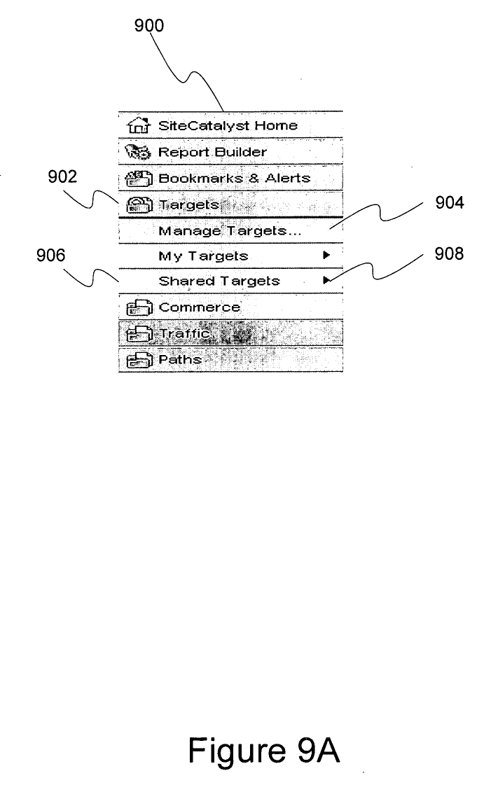

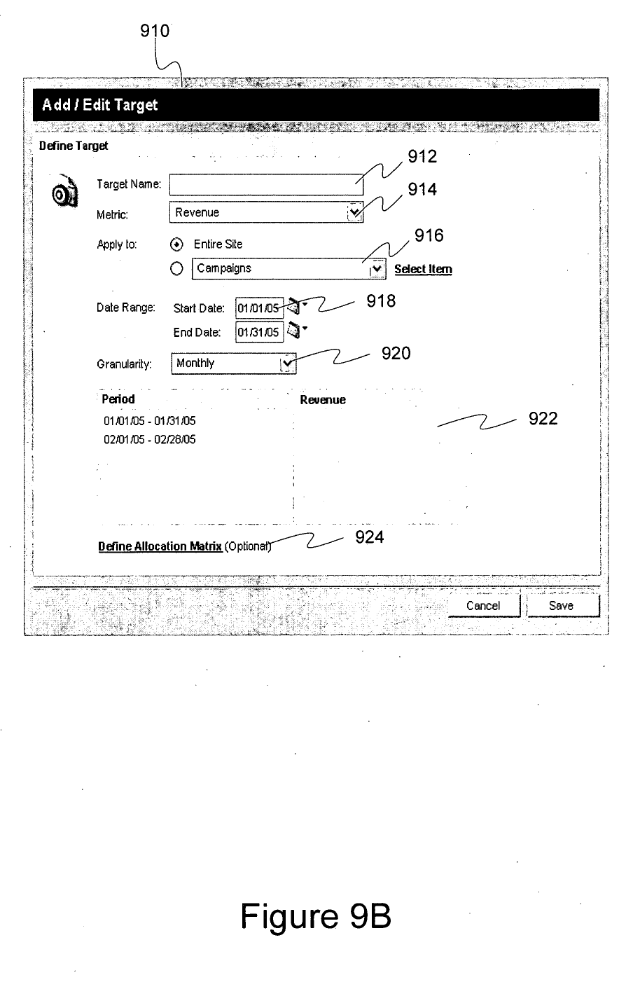

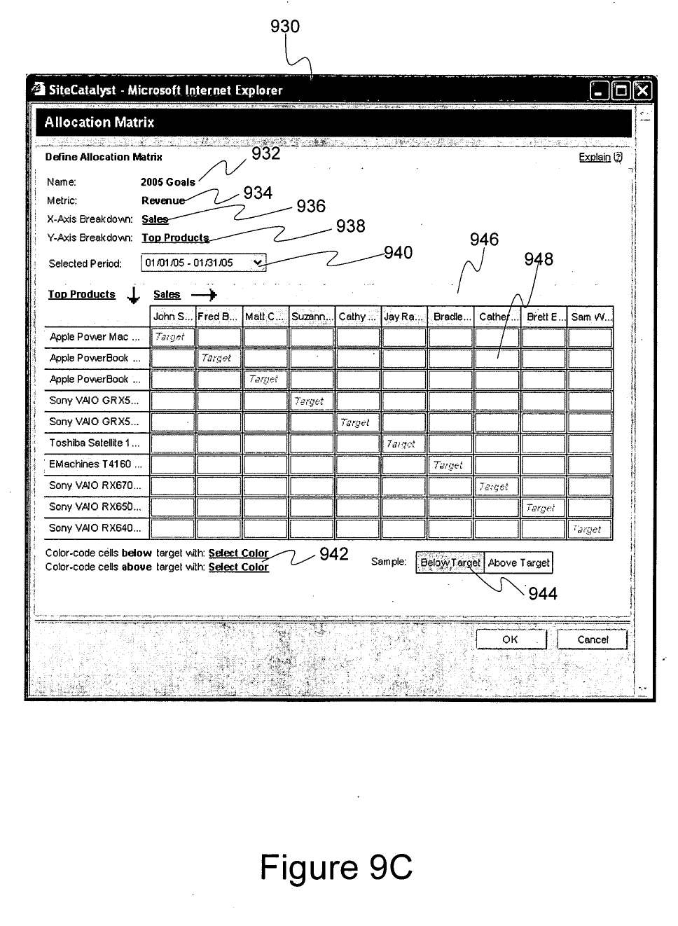

As has been noted above, the present invention includes the targets module 212 to allow the user to set targets and compare actual data to those targets. The present invention is particularly advantageous because these targets provide better ‘Management by Objective’ and ‘Management by Exception’ capabilities in a web analytics tool 210. Referring now to FIG. 8, one embodiment of a method for creating targets will be described. The method begins in step 802 by displaying a menu option for targets. This menu option is selectable by the user and allows the user to manage and create targets. An exemplary embodiment of such a user interface for the menu option is shown in FIG. 9A.

FIG. 9A is a graphical representation of a portion 900 of user interface for creating targets according to the present invention. The user interface include a left menu 900 to which a targets option 902 has been added. The interface 900 also includes a plurality of submenus. A Manage Targets submenu 904 generates another user interface as will be described below with reference to FIG. 9B. The My Targets submenu 906 generates a display such as a folder that shows the targets defined by the user. The Shared Targets 908 generates a display such as a folder that shows the targets shared by the user.

The method continues by receiving 804 inputs from the user to manage targets. The method then displays 806 a user interface to add/edit targets. An exemplary embodiment of such user interface for add/edit of targets is shown in FIG. 9B.

FIG. 9B is a graphical representation of a user interface 910 for creating or editing targets according to the present invention. The user interface 910 advantageously provides a plurality of fields 912, 914, 916, 918, 920, and 922. The first field 912 provides an area in which the user can input the name of the target. A second field 914 allows the user to specify which metric is going to be measured. For example, targets can be created for any metric such as revenue, click throughs, other parameters of Web traffic, and calculated metrics. A third field 916 allows the user to specify whether the target should apply to an entire web site or specific campaigns within a web site. Selection of such specific campaigns can be presented in a pulldown menu. Additional fields 918 allow the user to specify a beginning date and an end date. Another field 920 allows a user to indicate a granularity field. Granularity field values can be: daily, weekly, monthly, quarterly, yearly, or the entire period. Granularity field values are shown based on Date Range field (e.g., do not show Monthly as an option if date range is only for three weeks). This user interface 910 preferably includes a table 922. The table 922 in the screen where the user enters target values is dynamically populated with the ‘Period’ values based on the chosen ‘Date Range’ and ‘Granularity’. In the table, the “Period” column shows the To and From date as shown in the picture (e.g. 01/01/05-01/01/05). For Daily granularity, the system shows the one date (e.g. Jan. 01/01/05). If a custom date range like 01/01/05 to 03/15/05 is selected and the granularity is selected as “monthly”—the “Period” column shows the following periods: 01/15/05-01/31/05; 02/01/05-02/28/05; 03/01/05-03/15/05. When “Entire Period” is chosen as the granularity, only one row in the table. Finally, the user interface 910 includes a button hypertext link 924 to access the matrix allocation editing user interface.

The system 100 then receives 808 input from the client regarding the targets. Next, the method determines 810 whether the user has selected to define a matrix allocation. If not, the method proceeds directly to step 816 as fully described in more detail below. If the user has selected to define or edit the matrix allocation, the targets module 212 displays a matrix allocation editing user interface. An exemplary embodiment of such a matrix allocation editing user interface 930 is shown in FIG. 9C.

When “Define Allocation Matrix” is chosen from the “Define Targets” screen, the exemplary embodiment of the matrix allocation editing user interface 930 as shown in FIG. 9C is displayed. This matrix allows the user to set targets at multi-dimensional level. (e.g., if a Revenue target is set for June 2005 as $10,000.) The user can use this screen to say, $7000 of it is to be generated by John for the Apple Power Mac . . . , and $3000 of it is to be generated by Fred for Apple PowerBook, etc. The user interface 930 includes various editable and display fields for defining an allocation matrix. The user interface 930 includes fields 932, 934, 936, 938, and 940 to allow the user to input a name for the allocation matrix, revenue for the allocation matrix, an x-axis breakdown, a y-axis breakdown, and they selected period, respectively. The user interface 930 further comprises a grid area 946 that is populated with information headers based upon the information that the user input for the x-axis breakdown field 936, and the y-axis breakdown field 938. Within the grid area 946, there is a plurality of fields 948 in which the user can enter target information. Finally, the user interface 930 includes buttons are hypertext links 942 that the user can select to color code the display of cells depending on whether the actual data is above or below the target, and a sample area 944 to show how cells will be color coded.

When the users come to this screen shown in FIG. 9C the first time, system 100 shows the text “Select” for the breakdown types in the header. Users can then select the dimensions for the X and Y axis. The user can then select the actual dimension values by clicking on the dimension name (with the arrow symbols) above the cells. The user is able to type the targets directly into the cell. Provided are X and Y axis scrollbars so that users can define as many cells as they wish. In the report, users can use the sub-header to select x-axis values for display. For y-axis, the system 100 provides a default of reporting mechanism of 50 per page with Next/Previous links. The bottom of the screen shows totals—Target Total (from Define Targets screen) and Allocation Total (total of all Cell values). This helps the user see if their allocation adds up to the Target value. If it does not add to the target value and the user selects OK for automatic generation of a warning message, not an error message. The Save button is in the “Define Targets” screen of FIG. 9B, so when the user leaves the Allocation Matrix, the values are temporarily saved. Only when the user chooses to Save the target will they be able to save both the target and allocation values.

Referring back to FIG. 8, through the matrix allocation editing user face, the system 100 receives 814 information about how the user wants data allocated across the matrix. Using the received information from step 814, the method continues by modifying or creating 816 a target with the information provided. It should be noted that the information used in the modifying or creating step 816 can be provided either from step 808 or step 814. Once the target has been modified or created, the target module 212 stores a target for use and monitoring.

Those skilled in the art will recognize that target information may also be imported, although not shown in the flow chart of FIG. 8. In such instances, the user provide in and profile with an import format that has fields similar to those shown in FIGS. 9B and 9C. For example, any variety of comma delimited, tab delimited, or tabular format may be used.

Display of Targets

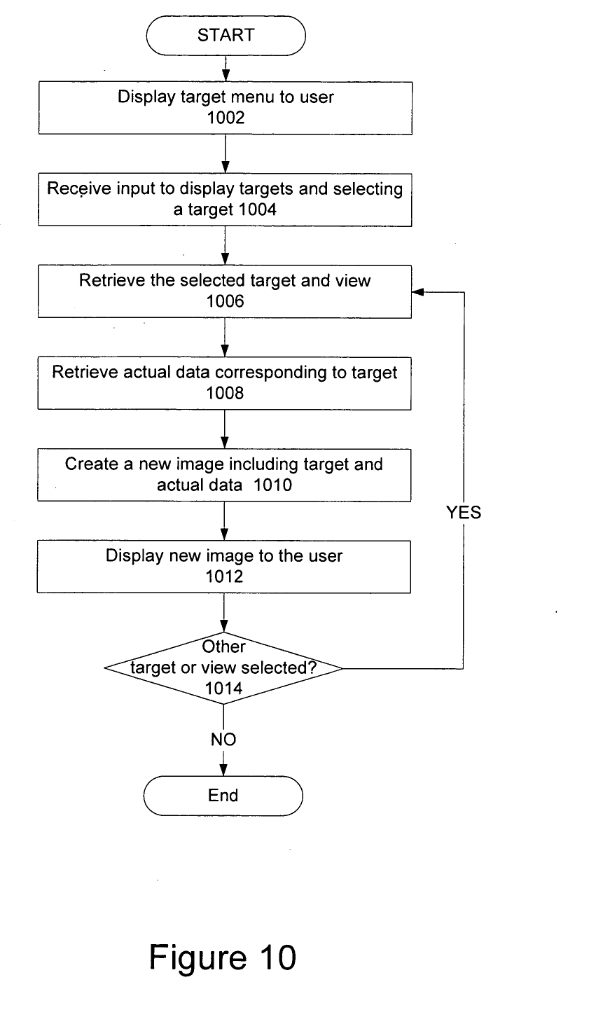

Referring now to FIG. 10, a method for displaying targets, in conjunction with reports from a Web analytics tool 210 will be described. The method begins by a displaying 1002 the target menu 902 to the user. This can be done using the exemplary user interface shown in FIG. 9A. Then the system 100 receives 1004 input to display targets and selecting a target. Next, the targets module 212 retrieves 1006 the selected target, and a view or report. The present invention advantageously allows the targets to be displayed across many reports. The targets module 212 retrieves 1008 actual data corresponding to the target. Then the targets module 212 and the calendar and targets user interface module 214 creates 1010 a new imaging including the target and the actual data. The system 100 then displays 1012 the new image to the user. Next, the method determines 1014 whether the user has selected another report. If so, the user is transitioning to view the data using another report. In such a case, the system 100 repeats steps 1006-1012 to generate a user interface that combines the information for the new report or new target.

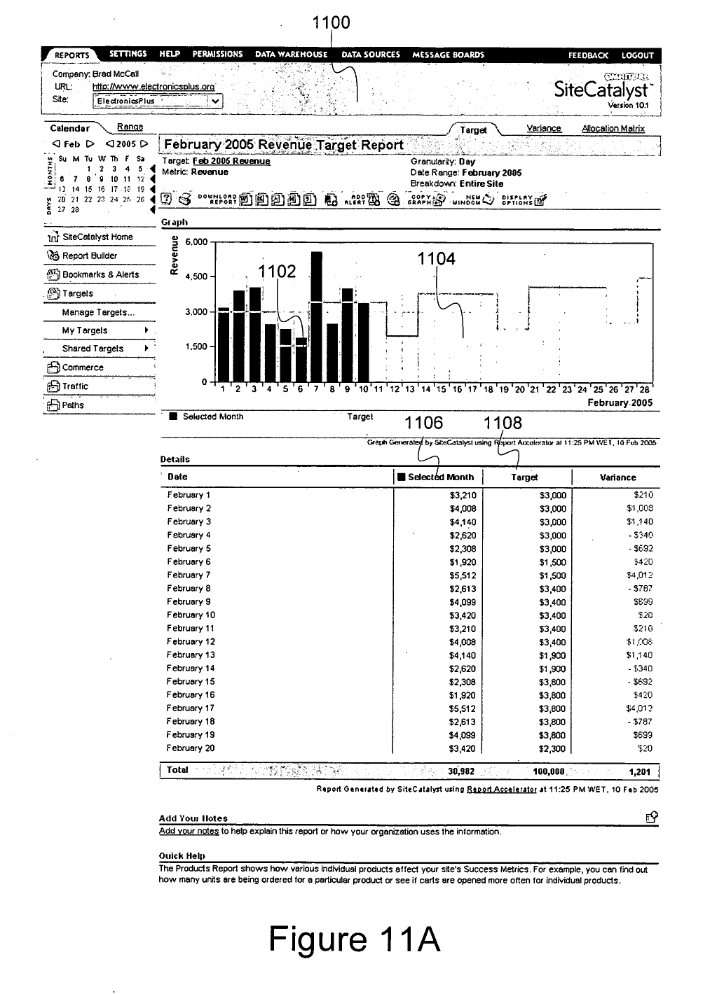

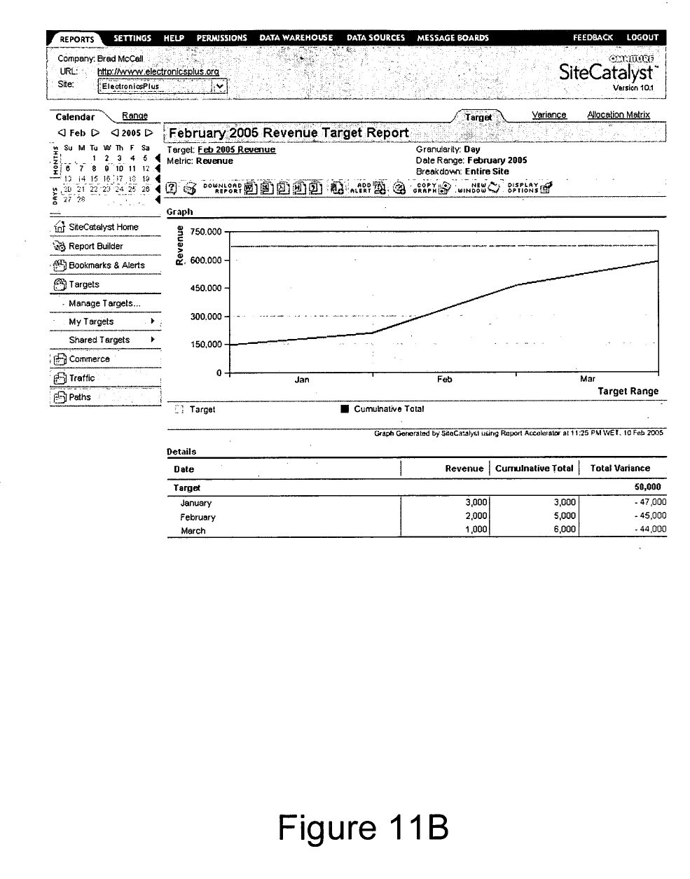

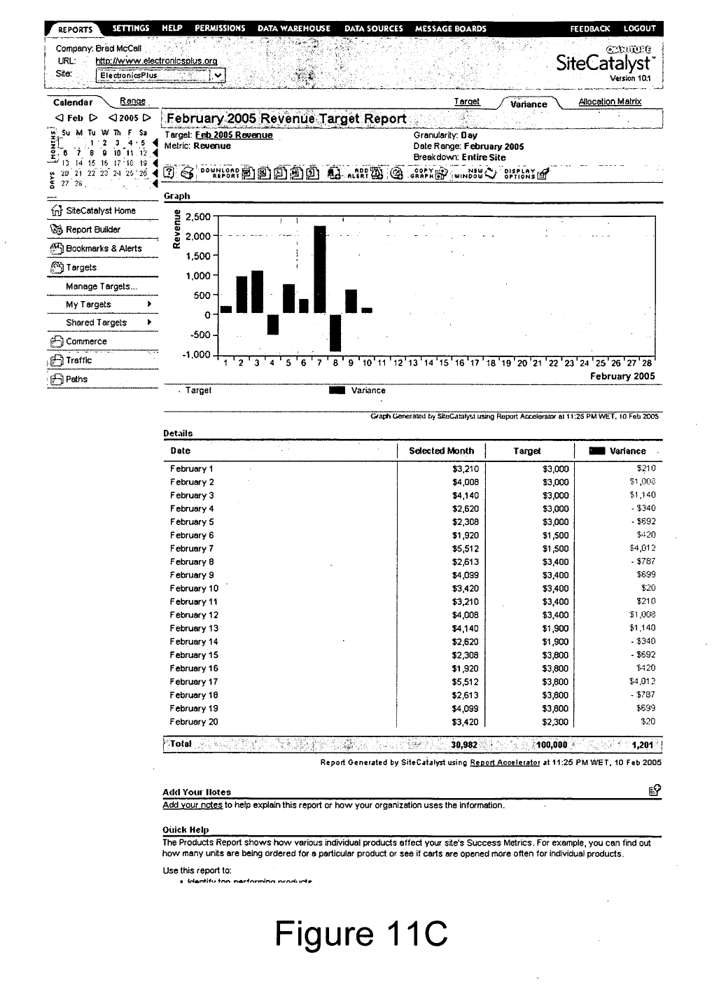

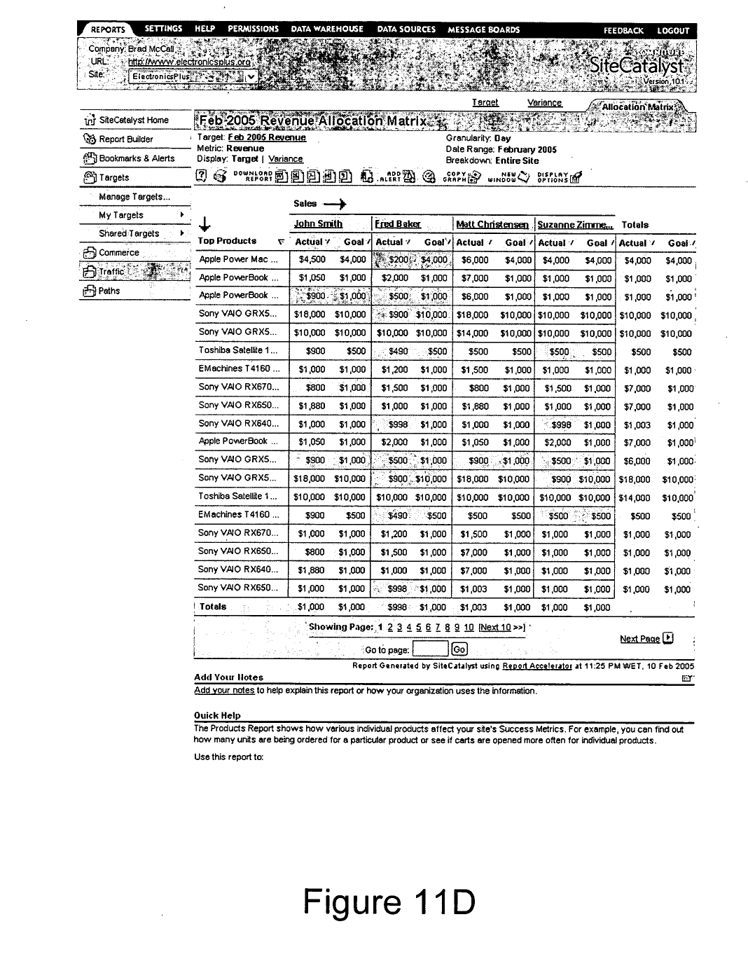

Referring now to FIG. 11A, an exemplary report showing actual data and targets in multiple formats can be seen. The report 1100 shown in FIG. 11A depicts two different sections with comparisons between actual and target data. The first section is a bar graph with the actual data shown in bars 1102 and the targets 1104 shown with shading. The second section is a table with a side-by-side comparison of actual data 1106 to target data 1108. In one embodiment of the present invention, the view shown in FIG. 11A is a default view. Referring now also to FIG. 11B the view changes if the granularity changes to the “Entire Period”. It should be noted that sub-header items are consistent in order of appearance with other reports provide by the Web analytics tool 210. Referring now to FIG. 11C, another exemplary report focusing on the variance between actual data and target data is shown. In this embodiment, the bar graph illustrates only the variance and no target date shown in the bar graph. However, in the table or details section the actual data, the target data, and the variance all remain visible. Based on the example shown in FIGS. 11A-11C, those skilled in the art will recognize that there are a variety of other formats and types of displays that may be used consistent with the present invention to display comparisons between target data and actual data. Referring now to FIG. 11D, and example of the allocation matrix populated with actual data and color-coded to reflect comparisons between the actual data and the targets is shown. FIG. 11D also illustrates that the user interface, may contain a variety of buttons for importing or exporting information, adding new targets, adding new alerts, or modifying display options. Other examples of user interfaces include ranked reports. If multiple metrics are being shown in the ranked view, there will be a default metric will be chosen for the targets. If none of them have targets the targets view is disabled.

While the present invention has been described with reference to certain preferred embodiments, those skilled in the art will recognize that various modifications may be provided. For example, certain embodiments may employ multiple application servers, acting in cooperation to perform a function or request. Any of the above functions or requests can be sent across a network. Variations upon and modifications to the preferred embodiments are provided for by the present invention.

What is claimed is:

1. A computer-implemented method for presenting data, the method comprising:
receiving user input to display augmented data;
retrieving augmentation information;
retrieving base data;
creating a report that includes the augmentation information and the base data;
displaying the report that shows both the augmentation information and the base data.

2. The computer-implemented method of claim 1, wherein the augmented information is a calendar event that identifies a time period.

3. The computer-implemented method of claim 2, wherein the augmented information is a calendar event includes a displayable text annotation.

4. The computer-implemented method of claim 2, wherein the augmented information is a plurality of calendar events, each calendar event displayable in a different visual format or color.

5. The computer-implemented method of claim 1, wherein the augmented information is a calendar event that identifies a time span or period.

6. The computer-implemented method of claim 1, wherein the augmented information is a sharable such that it is visible by other users.

7. The computer-implemented method of claim 1, wherein the augmented information is displayed on a plurality of reports.

8. The computer-implemented method of claim 2, wherein the calendar event is a starting point, a line and an endpoint.

9. The computer-implemented method of claim 1, wherein the augmented information is a target for a specified metric.

10. The computer-implemented method of claim 9, wherein the target includes a period and is displayable by period.

11. The computer-implemented method of claim 9, wherein the target includes an allocation matrix having a plurality of cells, each cell storing and displaying an individual target.

12. The computer-implemented method of claim 1, wherein the base data is shown in a graph, and the augmentation information is shading of the graph.

13. The computer-implemented method of claim 1, wherein the base data is shown in a table and the augmentation information is column added to the table.

14. The computer-implemented method of claim 1, wherein the augmentation information is a target, and further comprising:
determining whether the base data exceeds the target; and
providing an alert if the base data exceeds the target.

15. The computer-implemented method of claim 1, wherein providing the alert comprises displaying an alert on the created report.

16. The computer-implemented method of claim 1, wherein providing the alert comprises displaying sending a message to a user that created the alert.

17. The computer-implemented method of claim 1, wherein the base data is web analytics data.

18. A computer readable memory storing a computer program executable by a processor, the computer program producing a user interface for base data, the user interface comprising:
a first report display area for displaying base data; and
an annotation proximate the base data, the annotation providing additional information about the base data.

19. The computer program product of claim 18, wherein the annotation is a calendar event that corresponds to a specific time period of the base data.

20. The computer program product of claim 18, wherein the annotation is a target that event that corresponds to a specific potion of the base data.

21. The computer program product of claim 18, wherein the user interface further comprises:
a second report display area for displaying base data; and
a second annotation proximate the base data in the second report area, the annotation providing additional information about the base data.

22. The computer program product of claim 21, wherein the first report display area has a graph format, the second report display area has a table format, and wherein the second annotation and the first annotation relate to the same calendar event.

23. The computer program product of claim 18, wherein the first report display area includes an allocation matrix having a plurality of cells, each cell storing and displaying an individual target.
